(19) United States
(12) Patent Application Publication
(10) Pub. No.: US 2025/0234400 A1
(43) Pub. Date: Jul. 17, 2025

(54) Connection setup for communication between a first and a second system component

(71) Applicant: Hilti Aktiengesellschaft, Schaan (LI)

(72) Inventors: Klaus HAUSER, Schwabmuenchen (DE); Benedikt BECKERT, Schwabmuenchen (DE)

(21) Appl. No.: 18/702,687

(22) PCT Filed: Oct. 27, 2022
(86) PCT No.: PCT/EP2022/080101

§ 371 Date: Apr. 18, 2024

(30) Foreign Application Priority Data
Nov. 11, 2021 (EP) 21207762.2

(51) Int. Cl. H04W 76/14; B25F 5/00

(52) U.S. Cl. CPC H04W 76/14; B25F 5/00

(57) ABSTRACT

A system containing a first system component and a second system component, wherein the first system component is in the form of a power tool or a charging apparatus, for example, and the second system component is in the form of a rechargeable battery, in particular, wherein the rechargeable battery can be optionally releasably connected to the power tool or charging apparatus. The first system component contains at least one first transceiver and one second transceiver, and the second system component contains at least one third transceiver and one fourth transceiver, wherein the first transceiver and the third transceiver are configured for a wired transmission device for a first volume of data, and the second transceiver and the fourth transceiver are configured for a wireless transmission device for a second volume of data.

The present invention relates to a system containing a first system component and a second system component, wherein the first system component is in the form of a power tool or a charging apparatus, for example, and the second system component is in the form of a rechargeable battery, in particular, wherein the rechargeable battery can be optionally releasably connected to the power tool or charging apparatus.

### BACKGROUND

Modern cordless power tools, for example hammer drills, saws, screwdrivers, grinders or the like, can be connected to one or more rechargeable batteries which are used to supply the power tool with electrical energy.

The rechargeable batteries are connected both mechanically and electrically to the power tool in a releasable manner by means of corresponding interfaces in such a manner that the electrical energy stored inside the rechargeable battery passes to the power tool. In addition to the mechanical and electrical connection between a rechargeable battery and a power tool, such moderate interfaces also often have a data transmission device. This data transmission device makes it possible to interchange different data and information in the form of electrical signals between the rechargeable battery and the power tool.

### SUMMARY OF THE INVENTION

Before the data and information are actually interchanged, an initial connection setup or authentication, so-called pairing, of the two communication participants is required so that it can be ensured that only authorized or intended participants can interchange data with one another. The apparatuses and methods for initial connection setup which are already known from the prior art are often technically complex, susceptible to interference and/or non-secure. In particular, when using Bluetooth for wireless data transmission, unauthorized entry to the imminent interchange of data and information and/or eavesdropping (that is to say spying) on the interchange of data and information may result while pairing two communication participants.

It is an object of the present invention to solve the problem described above and to provide a system which makes it possible to interchange data and information in a simple and, in particular, secure manner.

The present invention provides a system (1) containing a first system component (2, 24) and a second system component (3), wherein the first system component (2, 24) is in the form of a power tool or a charging apparatus, for example, and the second system component (3) is in the form of a rechargeable battery, in particular, wherein the rechargeable battery can be optionally releasably connected to the power tool or charging apparatus, characterized in that the first system component (2, 24) contains at least one first transceiver (14, 14′) and one second transceiver (15, 15′), and the second system component (3) contains at least one third transceiver (20) and one fourth transceiver (21), wherein the first transceiver (14, 14′) and the third transceiver (20) are configured for a wired transmission device (13) for a first volume of data, and the second transceiver (15, 15′) and the fourth transceiver (21) are configured for a wireless transmission device (16) for a second volume of data.

The present invention also provides a system containing a first system component and a second system component, wherein the first system component is in the form of a power tool or a charging apparatus, for example, and the second system component is in the form of a rechargeable battery, in particular, wherein the rechargeable battery can be optionally releasably connected to the power tool or charging apparatus.

The invention provides for the first system component to contain at least one first transceiver and one second transceiver, and for the second system component to contain at least one third transceiver and one fourth transceiver, wherein the first transceiver and the third transceiver are configured for a wired transmission device for a first volume of data, and the second transceiver and the fourth transceiver are configured for a wireless transmission device for a second volume of data.

Using wired transmission makes it possible to reduce the possibility of unauthorized entry to the imminent interchange of data and information or eavesdropping on the interchange of data and information. In addition, using a wired transmission device and a wireless transmission device makes it possible to dispense with the use of two different wireless transmission devices.

The transceiver may also be referred to as a transceiving device. However, it is also possible in this case for the transceiver to be in the form of a transmitting unit and a receiving unit, wherein both the transmitting unit and the receiving unit are each implemented as separate components.

The rechargeable battery is used to supply the power tool with electrical energy when the rechargeable battery and the power tool are connected to one another. Furthermore, the rechargeable battery can be supplied with electrical energy by the charging apparatus when the rechargeable battery and the charging apparatus are connected to one another.

The first transceiver and the third transceiver are thus configured and matched to one another in such a manner that data and information can be interchanged in the form of signals between the first and the third transceiver by means of a wired transmission device. In one exemplary embodiment, the wired transmission device may be in the form of a line between the first and the third transceiver. According to an alternative embodiment, the first and the third transceiver may be part of a data bus system.

According to one advantageous configuration of the present invention, it may be possible for the first volume of data to be configured for an initial connection setup between the first system partner and the second system partner. The process of initial connection setup can also be referred to as pairing.

The second transceiver and the fourth transceiver are thus configured and matched to one another in such a manner that data and information can be interchanged in the form of signals between the second and the fourth transceiver by means of a wireless transmission device.

According to one advantageous configuration of the present invention, it may be possible for the wireless transmission device for the second volume of data and the second transceiver and the fourth transceiver to be configured on the basis of a Bluetooth technology. This makes it possible to easily interchange a relatively large volume of data and information between the communication participants. The second volume of data includes, inter alia, the regularly transmitted state of charge (SoC) or state of health (SoH) of the rechargeable battery.

Alternatively, any other wireless signal transmission technology or radio technology can also be used to interchange data and information between the communication participants.

### BRIEF DESCRIPTION OF THE DRAWINGS

Further advantages will become apparent from the following description of the figures. Various exemplary embodiments of the present invention are illustrated in the figures.

The figures, the description and the claims contain numerous features in combination. A person skilled in the art will expediently also consider the features individually and combine them to form useful further combinations.

Identical and similar components are denoted by the same reference signs in the figures. In the drawing:

FIG. 1 shows a system according to a first embodiment having a power tool as a first system component and a rechargeable battery connected to the power tool as a second system component; and

FIG. 2 shows a system according to a second embodiment having a charging apparatus as a first system component and the rechargeable battery connected to the charging apparatus as a second system component.

### DETAILED DESCRIPTION

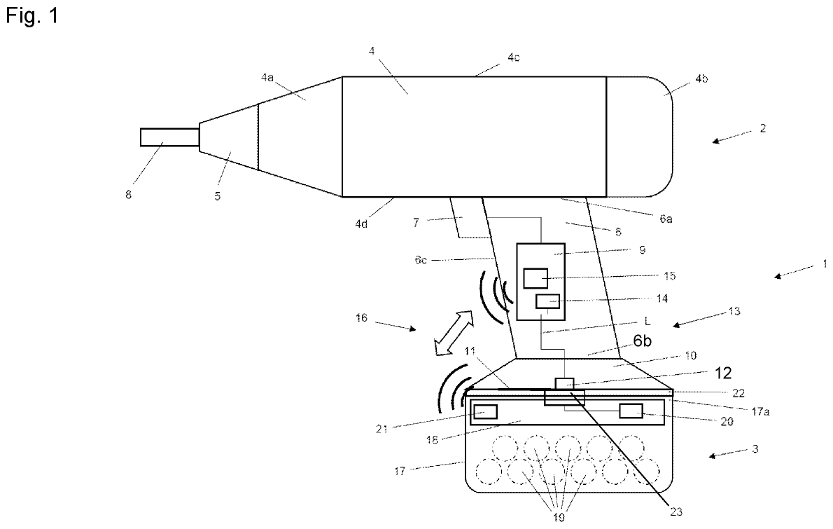

FIG. 1 shows a system 1 according to the invention according to a first exemplary embodiment having a first system component and a second system component.

In this case, according to the first exemplary embodiment, the first system component is in the form of a power tool 2 and the second system component is in the form of a rechargeable battery 3. The power tool 2 illustrated in FIG. 1 is in the form of a cordless screwdriver, for example. The second system component in the form of a rechargeable battery 3 is releasably connected to the first system component in the form of a power tool 2 in FIG. 1.

Alternatively, the power tool 2 can also be in the form of a hammer drill, a drill, a grinder, a saw or the like.

As is likewise clear in FIG. 1, the power tool 2 in the form of a cordless screwdriver contains substantially a tool housing 4, a tool fitting 5 and a handle 6.

The handle 6 in turn contains an upper end 6a and a lower end 6b, and is used by a user to hold and guide the power tool 2. An activation switch 7 is positioned on a front side 6c of the handle 6. A user can use the activation switch 7 to adjust the power tool 2 from a deactivation state into an activation state. In this case, the activation switch 6 contains a potentiometer.

The tool housing 4 in turn contains a front end 4a, a rear end 4b, a top side 4c and an underside 4d.

The tool fitting device 5 is positioned at the front end 4a of the tool housing 4. The tool fitting 5 serves to receive and hold a tool 8. In the present exemplary embodiment, the tool 8 is in the form of a bit (also referred to as a screwdriver bit).

A drive, a gear mechanism, a control unit 9 and a drive shaft are positioned inside the tool housing 4. The control unit 9 contains a storage unit for storing and providing data and information. The drive, the gear mechanism and the drive shaft are arranged with respect to one another in this case in such a manner that a torque generated by the drive can be transmitted to the drive shaft via the gear mechanism. The drive shaft is in turn connected to the tool fitting 5, with the result that the torque can also be transmitted to the tool fitting 5 and finally to the tool 8 in the form of a bit.

The drive is in the form of a brushless electric motor. Alternatively, however, the drive can also be in the form of an electric motor with carbon brushes.

The upper end 6a of the handle 6 is secured to the underside 4d of the tool housing 4.

A base apparatus 10 containing a tool interface 11 is positioned at the lower end 6b of the handle 6. The tool interface 11 serves for releasably connecting the rechargeable battery 3 to the power tool 2.

The tool interface 11 in turn contains a positive contact, a negative contact and a communication contact 12. As also described in detail below, the positive contact and the negative contact are used to produce a circuit so that electrical energy can pass from the rechargeable battery to the power tool 2.

The communication contact 12 is part of a wired transmission device 13 for interchanging data and information between the power tool 2 and another communication partner (for example the rechargeable battery 3).

In the present exemplary embodiment, the control unit 9 is positioned inside the handle 6. Alternatively, the control unit 9 may also be positioned at another suitable location in or on the power tool 2. The control unit 9 is used to control and regulate the different functions of the power tool 2.

The control unit 9 also contains a first transceiver 14 and a second transceiver 15.

The first transceiver 14 is part of the wired transmission device 13 for interchanging data and information between the power tool 2 and another communication partner. For this purpose, the first transceiver 14 is connected to the communication contact of the power tool 2 by means of a line in such a manner that data and information can be interchanged in the form of signals between the first transceiver 14 and the communication contact of the power tool 2.

The second transceiver 15 is in turn part of a wireless transmission device 16 for interchanging data and information between the power tool 2 and another communication partner.

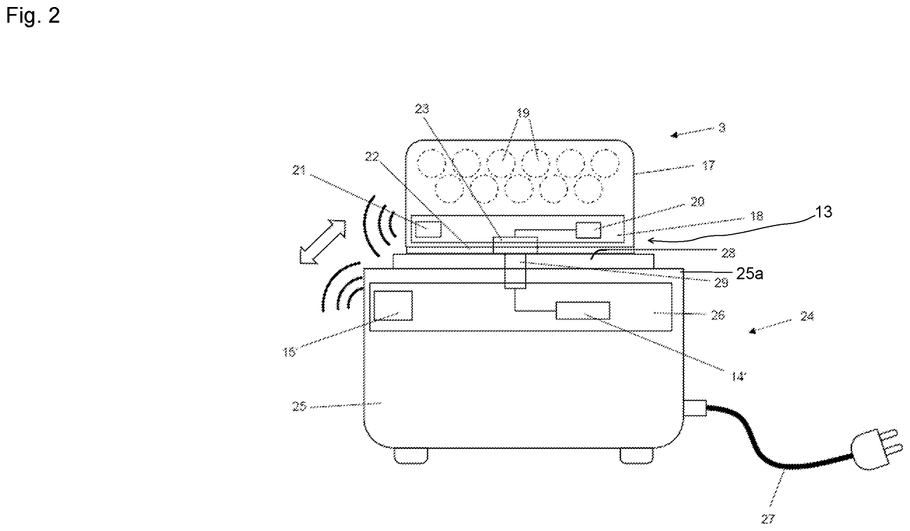

According to the exemplary embodiment illustrated, the rechargeable battery 3 illustrated in FIGS. 1 and 2 contains substantially a rechargeable battery housing 17, a control unit 18, and a number of energy storage cells 19 (also called rechargeable battery cells).

The control unit 18 contains a storage unit for storing and providing data and information.

The energy storage cells 19 are positioned inside the rechargeable battery housing 17 and are used to draw, store and provide electrical energy. Each individual energy storage cell 19 is connected to the control unit 18 via a corresponding line L. In addition, the energy storage cells 19 are connected to the positive contact and to the negative contact of the rechargeable battery 3, with the result that the electrical energy stored in the energy store cells 19 can be tapped off at the positive contact and the negative contact.

The control unit 18 is used to control and regulate the different functions of the rechargeable battery 3. The control unit 18 also contains a third transceiver 20 and a fourth transceiver 21.

The third transceiver 20 of the rechargeable battery 3 is part of the wired transmission device 13 for interchanging data and information between the rechargeable battery 3 and another communication partner. The fourth transceiver 21 of the rechargeable battery 3 is in turn part of the wireless transmission device 16 for interchanging data and information between the rechargeable battery 3 and another communication partner (for example the power tool 2 or the charging apparatus 24).

On a top side 17a, the rechargeable battery housing 17 contains a rechargeable battery interface 22 which corresponds to the tool interface 11 and is used to releasably connect the rechargeable battery 3 to the power tool 2. The rechargeable battery interface 22 in turn contains a positive contact, a negative contact and a communication contact 23. In order to connect the rechargeable battery 3 to the power tool 2, the rechargeable battery interface 22 is brought into contact with the tool interface 11 in such a manner that the respective positive contacts, negative contacts and communication contacts 23 are connected to one another. Making contact with the positive contacts and negative contacts makes it possible to close a circuit such that electrical energy can pass from the energy storage cells 19 of the rechargeable battery 3 to the power tool via the respective interfaces 11, 22.

As a result of the fact that the communication contact 12 of the power tool 2 and the communication contact 23 of the rechargeable battery 3 are connected, data and information can be interchanged in the form of signals between the rechargeable battery 3 and the power tool 2.

FIG. 2 shows a system according to the invention according to a second exemplary embodiment having a first system component and a second system component. The first system component is in the form of a charging apparatus 24 and the second system component is in the form of the rechargeable battery 3.

The charging apparatus 24 is used to supply a connected rechargeable battery 3 with electrical energy and in this case contains substantially a charging apparatus housing 25, a control apparatus 26 and an energy supply 27.

The control apparatus 26 contains a storage unit for storing and providing data and information.

On a top side 25a, the charging apparatus housing 25 also contains a charging apparatus interface 28 which is used to releasably connect the charging apparatus 24 to the rechargeable battery 3.

The charging apparatus interface 28 in turn contains a positive contact, a negative contact and a communication contact 29. The positive contact and the negative contact are used to produce a circuit so that electrical energy can pass from the charging apparatus 24 to the rechargeable battery 3, in particular to the energy storage cells 19.

The communication contact 29 of the charging apparatus 24 is part of a wired transmission device 13 for interchanging data and information between the charging apparatus 24 and another communication partner (for example the rechargeable battery 3).

The control apparatus 26 is used to control and regulate the different functions of the charging apparatus 24. In addition, the control apparatus 26 contains a first transceiver 14′ and a second transceiver 15′.

The first transceiver 14′ is part of a wired transmission device 13 for interchanging data and information between the charging apparatus 24 and another communication partner. For this purpose, the first transceiver 14′ is connected to the communication contact 29 of the charging apparatus 24 by means of a line such that data and information can be interchanged in the form of signals between the first transceiver 14′ and the communication contact 29 of the charging apparatus 24.

As can be seen in FIG. 2, the energy supply 27 is in the form of a power cable. The charging apparatus 24 can be connected to a power grid (that is to say a socket) by means of the energy supply 27 in the form of the power cable.

Alternatively, the charging apparatus 24 may also be in the form of a mobile energy supply device. Such mobile energy supply devices may also be referred to as a power bank.

In the present exemplary embodiment, the wireless transmission device 16 for interchanging data and information is based on a Bluetooth technology.

If communication, that is to say interchanging of data and information in the form of signals, is intended to take place between the first system component 2, 24 and the second system component 3, an initial connection setup or authentication, so-called pairing, of the two system components 2, 3, 24 (or communication participants) is first of all required. The pairing is used to determine whether the two communication participants actually match one another and are allowed to or can interchange data with one another.

For the initial connection setup (that is to say pairing), a first volume of data is transmitted from the first transceiver 14, 14′ of the first system component 2, 24 to the third transceiver 20 of the second system component 3 via the wired transmission device 13. After a successful connection setup (that is to say pairing), the two system components 2, 3, 24 are coupled to one another, with the result that communication with interchange of data and information can be carried out between the two system components 2, 3, 24.

Interchange of data and information with large quantities of signals then takes place between the second transceiver 15, 15′ of the first system component 2, 24 and the fourth transceiver 21 of the second system component 3, 24 via the wireless transmission device.

### LIST OF REFERENCE SIGNS

1 System
2 Power tool
3 Rechargeable battery
4 Tool housing
4a Front end of the tool housing
4b Rear end of the tool housing
4c Top side of the tool housing
4d Underside of the tool housing
5 Tool fitting
6 Handle
6a Upper end of the handle
6b Lower end of the handle
6c Front side of the handle
7 Activation switch
8 Tool
9 Control unit
10 Base apparatus
11 Tool interface
12 Communication contact of the power tool
13 Wired transmission device
14, 14′ First transceiver
15, 15′ Second transceiver
16 Wireless transmission device
17 Rechargeable battery housing
17a Top side of the rechargeable battery housing
18 Control unit
19 Energy storage cell
20 Third transceiver
21 Fourth transceiver
22 Rechargeable battery interface
23 Communication contact of the rechargeable battery
24 Charging apparatus
25 Charging apparatus housing
26 Control apparatus
27 Energy supply of the charging apparatus
28 Charging apparatus interface
29 Communication contact of the charging apparatus
L Line

What is claimed is:

1-3. (canceled)

4. A system comprising:
a first system component and a second system component, the first system component being in the form of a power tool or a charging apparatus, and the second system component being in the form of a rechargeable battery, the rechargeable battery optionally releasably connected to the power tool or charging apparatus,
the first system component including at least one first transceiver and one second transceiver, and the second system component including at least one third transceiver and one fourth transceiver, the first transceiver and the third transceiver being configured for a wired transmission of a first volume of data, and the second transceiver and the fourth transceiver being configured for a wireless transmission of a second volume of data.

5. The system as recited in claim 4 wherein the first volume of data is configured for an initial connection setup between the first system component and the second system component.

6. The system as recited in claim 4 wherein the wireless transmission device for the second volume of data and the second transceiver and the fourth transceiver are configured on the basis of a Bluetooth technology.
